(19) United States
(12) Patent Application Publication
(10) Pub. No.: US 2008/0046313 A1
(43) Pub. Date: Feb. 21, 2008

(54) Methods and apparatus for serving relevant advertisements using web browser bars

(76) Inventor: Shuwei Chen, San Marcos, TX (US)

Correspondence Address: SHUWEI CHEN, 1200 MOUNTAIN VIEW DR., SAN MARCOS, TX, 78666, US

(21) Appl. No.: 11/465,269

(22) Filed: Aug. 17, 2006

(51) Int. Cl. G06Q 30/00

(52) U.S. Cl. 705/14

(57) ABSTRACT

Serving relevant advertisements using web browser bars. Web browser bars are small window widgets along with the borders of a browser and may be customized for a variety of purposes. In one embodiment, a customized Explorer bar is added as extension to Microsoft Internet Explorer web browser. While a user browses online using the browser, the content related advertisements may be shown on the bar. If the one of advertisements is selected in the bar, the detailed advertisement page will be shown on the browser page content window. The advertisements on the bar may be updated when the user browses different pages.

### BACKGROUND OF THE INVENTION

A. Field of the Invention

The present invention relates generally to advertising and, more particularly, to serving relevant advertisements using web browser.

B. Description of Related Art

Web browser-based online advertising has been widely accepted for serving relevant advertisements (“ads”) to targeted audience. For example, some websites provide an information search functionality that is based on query keywords entered by the user seeking information. This user query can be used as an indicator of the type of information of interest to the user. By comparing the user query to a list of keywords specified by an advertiser, it is possible to provide some form of targeted advertisements to these search service users. An example of such a system is the Adwords system offered by Google, Inc.

For web pages which do not offer search functionality, one way of serving relevant advertisement is to insert some code of computer program within the page content. This code will be executed to request ads relevant to the page content when the page is rendered. The relevant ads will be rendered in conjunction with the page content. An example of such a system is the Adsense system offered by Google, Inc.

While these systems such as Adwords and Adsense have provided advertisers the ability to better target audience; their effectiveness is limited due to the fact that ads are rendered as part of page content. Ads are “hosted” by a page (site). To ad audiences, ad access is limited to “hosted” sites.

It would be useful to have methods and apparatus for providing ads that are only relevant to web page content, regardless which sites the content are from. For example, if an ad is about digital camera sale, when an audience visits any web site whose topics are about digital camera, the ad will be delivered to the audience. This will greatly increase the ad delivering channels and ad exposure. Web browser bars fit this need perfectly.

Web browser bars are a standard browser technology for Microsoft Internet Explorer (IE) and Mozilla Firefox (These two browsers contribute over 95% market shares in the web browser market, and other browsers are adopting the technology gradually). Browser bars are typically small windows along the browser borders and provide browsing-related help functions, such as browsing history, news or weather channels, etc. For example, for Microsoft Internet Explorer (IE), the Explorer Bar is at the left side of the browser and is used to show history, favorite and other information. Both IE and Firebox provide application programming interface (API) to allow third parties to write their own browser bar program. With the API, browser bar can access the page content and manage page navigation.

Although web browser bars have been used for a variety of purposes, it has never been used to serve ads relevant to the page content.

### SUMMARY OF THE INVENTION

Systems and methods consistent with the present invention address this and other needs by serving relevant advertisements using web browser bars, including: identifying targeting information for an advertisement; identifying a set of one or more topics for the web page based on the content of the targeted page; comparing the targeting information to the set of topics to determine if the advertisement is relevant to the web page; displaying advertisements on the web browser bars; providing interaction between the browser bar and the browser page content window.

Additional aspects of the present invention are directed to computer systems and to computer-readable media having features relating to the foregoing aspects.

### BRIEF DESCRIPTION OF THE DRAWINGS

The accompanying drawings, which are incorporated in and constitute a part of this specification, illustrates an embodiment of the invention and, together with the description, explains the invention. In the drawings,

FIG. 0 is a diagram illustrating two online advertising systems: one is the traditional system using “hosted” sites; another one is the system within which the invention may be implemented;

FIG. 1 is a diagram illustrating an environment within which the invention may be implemented;

FIG. 2 is a diagram functionally illustrating an advertising system consistent with the invention;

FIG. 3 is a diagram illustrating apparatus with which the invention may be implemented;

FIG. 4 is a flow diagram of an exemplary method for providing relevant advertisements, consistent with the present invention; and

FIG. 5 is a diagram functionally illustrating a user interface layout of a simplified web browser with advertisement bar.

### DETAILED DESCRIPTION

The following detailed description of the invention refers to the accompanying drawings. The detailed description does not limit the invention. Instead, the scope of the invention is defined by the appended claims and equivalents.

The present invention involves methods and apparatus for serving advertisements relevant to a target web page using web browser bars. In one implementation, a list of topics corresponding to the web page is generated by analyzing the content of the web page. The list of topics is compared to target information associated with the advertisements (e.g., keywords specified for the advertisements) to determine which of the advertisements are relevant to the web page. Some or all of these relevant advertisements may then be associated with the web page so that they may be presented on the browser bar.

Selecting ads on the browser bar may cause detailed ad page shown on the browser page content window. When the audience navigates to another page, the ads on the bar maybe updated to be relevant to the new page content. The page viewing behaviors, such as navigation history and individual page viewing time, may be recorded and analyzed by the browser bar.

Those skilled in the art will recognize that many other implementations are possible, consistent with the present invention.

A. Environment and Architecture

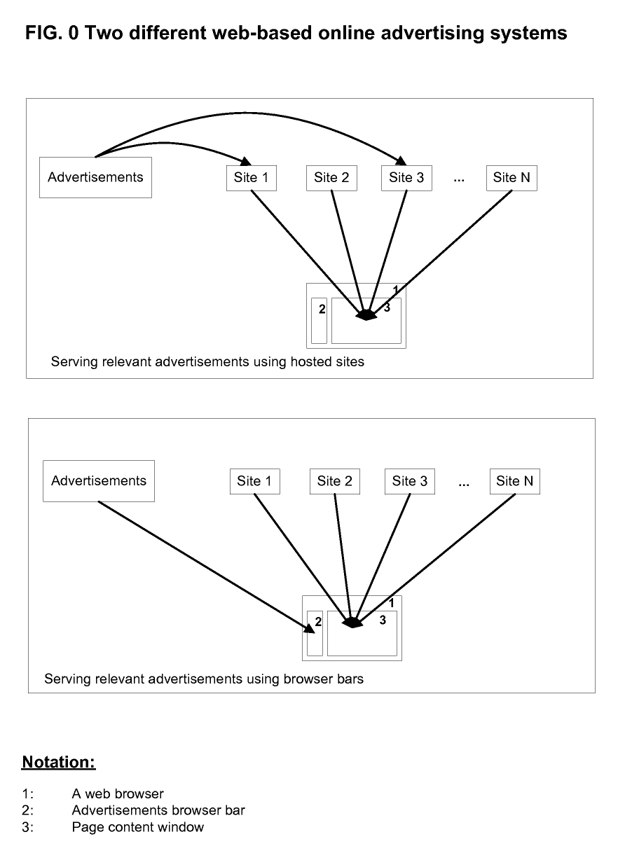

FIG. 0 is a diagram illustrating two online advertising systems: one is the traditional system using “hosted” sites; another one is the system within which the invention may be implemented. In the traditional system, site 1, site 2 and site 3 provide similar content; advertisements (ads) are related to the content; however, ads are delivered when the browser visits site 1 and site 3 but not site 2 because ads are “hosted” by site 1 and site 3. On the other hand, in the system with the invention may be implemented, advertisements will be delivered when the browser visits any content relevant sites. This greatly increases ad delivery channels and so ad exposure.

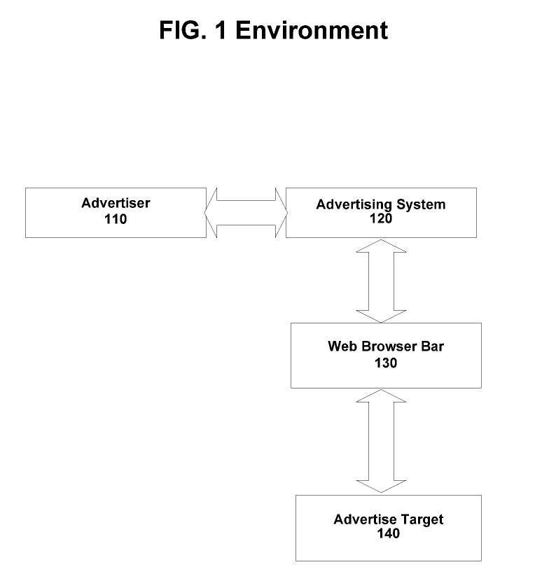

FIG. 1 is a diagram illustrating an environment within which the invention may be implemented. The environment includes an advertiser 110, an advertising system 120, a browser bar program 130, and an advertising target 140.

Advertiser 110 may be the party that directly sells the goods or services being advertised or an agent authorized to act on the advertiser's behalf.

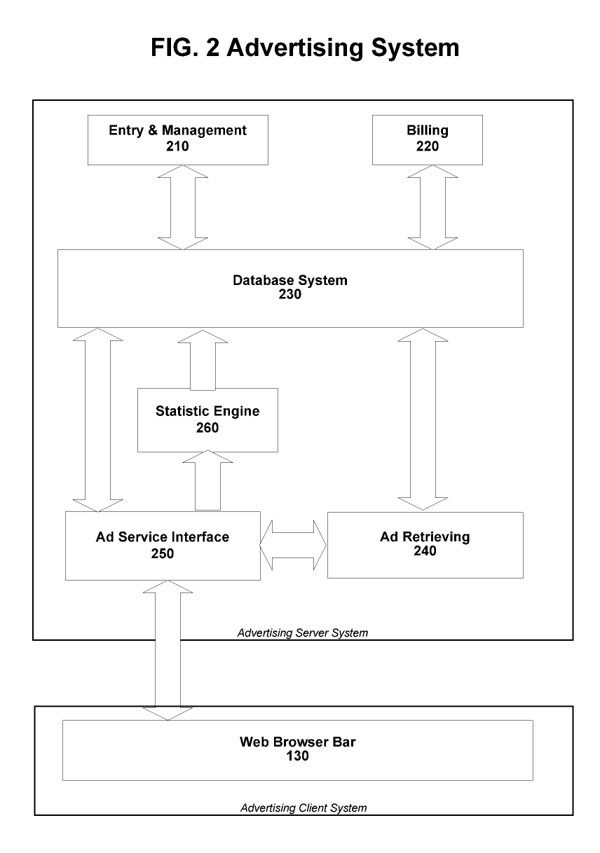

Advertising system 120 interfaces with both the advertiser 110 and the web browser bar program 130. It may perform a variety of functions, as explained in more detail below in reference to FIG. 2. This invention may be used with such an advertising system 120.

Web browser bar program 130 is the entity that will issue a request for advertisements to advertising system 120, obtain the advertisements from advertising system 120, and present the advertisement to the advertising target 140. The browser bar 130 may also be responsible for tracking the user's web navigation history. The navigation history may be used for content analysis.

Advertising target 140 is the individual (or set of individuals) who ultimately receive the advertisement. In the case of visual advertisements, for example, the advertisement target 140 is the person who views the advertisement.

FIG. 2 is a diagram functionally illustrating an advertising system consistent with the invention. The system includes an ad campaign entry and management component 210, a billing component 220, one or more databases 230, an ad retrieving component 240, an ad service interface component 250, and a statistics engine component 260. To help understand the invention, other components of the advertising system will be explained below. Furthermore, although FIG. 2 shows a particular arrangement of components constituting advertisement system 120, those skilled in the art will recognize that not all components need be arranged as shown, not all components are required, and that other components may be added to, or replace, those shown.

Ad entry and management component 210 is the component by which the advertiser enters information required for an advertising campaign and manages the campaign. An ad campaign contains one or more advertisements that are related in some manner. For example, the Dell Inc may have an ad campaign for zero percent financing, which could contain a series of advertisements related to that topic. Among the other things that could be provided by an advertiser through ad entry and management component 210 are the following: one or more advertisements (“ads”), one or more set of keywords associated with those ads, geographic targeting information, ads audience profile targeting information, a value indication for the advertisement, start date, end date, etc. The data required for, or obtained by, ad entry and management component 210 resides in one of the databases 230.

Billing component 220 helps perform billing-related functions. For example, billing component 220 generates invoices for a particular advertiser 110 or ad campaign. In addition, billing component 220 may be used by advertiser 110 to monitor the amount being expended for its various campaigns. The data required for, or obtained by, billing component 220 resides in a database 230.

Databases 230 contain a variety of data used by advertising system 120. In addition to the information mentioned above in reference to ad entry and management system 210, databases 230 may contain statistical information about what ads have been shown, how often they have been shown, the number of times they have been selected, who has selected those ads, how often display of the ad has led to consummation of a transaction, etc. Although the databases 230 are shown in FIG. 2 as one unit, one of ordinary skill in the art will recognize that multiple databases may be employed for gathering and storing information used in advertising system 120.

Ad service interface 250 is a component that interfaces with the browser bar 130 to obtain or send information. For example, browser barn 30 may send a request for one or more advertisements to ad service interface 250. The request may include information such as the site requesting the advertisement, any information available to aid in selecting the advertisement, the number of ads requested, etc. In response, ad service interface 250 may provide one or more advertisements to browser bar 130. In addition, browser bar 130 may send information about the performance of the advertisement back to the ad system via the ad service interface 250. This may include, for example, the statistical information described above in reference to a database 230. Browser bar 130 may also send back the user's web navigation history and these information could be used for generating topics for a target web page. The data required for, or obtained by, ad service interface component 250 resides in a database 230.

Ad retrieving component 240 receives a request for a specified number of advertisements, coupled with information to help select the appropriate advertisements. This information may include, for example, specific location specified by an end user. This component also determines a preference order in which they should be rendered to an end user. For example, relevant ads may be ordered based on the value indication associated with each ad. These ordered ads may be provided to the web browser bar 130.

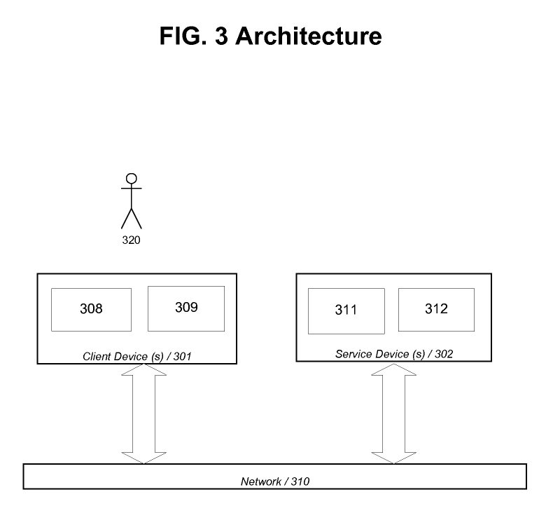

FIG. 3 is a diagram illustrating an architecture in which the present invention may be implemented. The architecture includes multiple client devices 301, a server device 302, and a network 310, which may be, for example, the Internet. Client devices 301 each include a computer-readable medium 309, such as random access memory, coupled to a processor 308. Processor 308 executes program instructions stored in memory 309. Client devices 301 may be personal computers, personal digital assistances, mobile phones, content players, and/or any device that can run a web browser.

Through client devices 301, requesters 320 can communicate over network 310 with each other and with other systems and devices coupled to network 310, such as server device 302. Requestors 320 may, for example, be advertisers 110, or advertising target 140.

Similar to client devices 301, server device 302 may include a processor 311 coupled to a computer readable memory 312. Server device 302 may additionally include a secondary storage element, such as a database 230. Server 302, although depicted as a single computer system, may be implemented as a network of computer processors.

Memory 312 may contain a number of programs, such as the components described above in reference to FIG. 2.

B. Operation

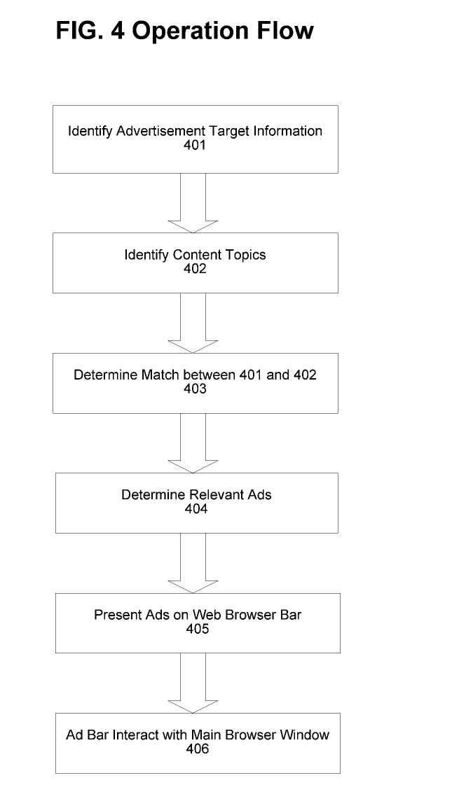

FIG. 4 is a flow diagram of an exemplary method for serving relevant advertisements using web browser bars, consistent with the present invention.

The exemplary method is not limited by the order shown in the flow diagram. The process identifies targeting information for an advertisement (Stage 410). The targeting information may be in the form of a list of keywords or phrases associated with the advertisement (e.g., “honda”, “honda cars”, “cars”, etc.), as provided by advertiser 110 through ad campaign entry and management component 210. The targeting information may also include other demographic information, such as geographic location, etc. Thus, the targeting information is simply some information from which a topic may be derived.

Next, the target web page is analyzed to identify a topic corresponding to that target web page (Stage 420). The target web page may be stored on a database 230 or may be provided by the browser bar 130 via ad service interface component 250. There are numerous ways in which the target web page may be analyzed to identify this topic.

The targeting information identified in stage 410 is compared to the one or more topics identified in stage 420 to determine if a match exists (Stage 430). A “match” need not be an exact match. Instead, a match is an indication of a relatively high degree of similarly, and/or a predetermined (e.g., absolute) degree of similarity. If a match exists, the advertisement is determined to be relevant to the target web page (stage 440) and may be provided to ad retrieving component 240, for eventual provision to the browser bar 130 via ad service interface component 250.

The advertisements are rendered on the browser bar 130 (stage 405). When one ad is selected, the page content of the browser page content window will be updated with ad detailed page. As the audience browsers different web pages, the ads on the browser bar may be updated (stage 406).

Those skilled in the art will also recognize that the functions described in each stage are illustrative only, and are not intended to be limiting.

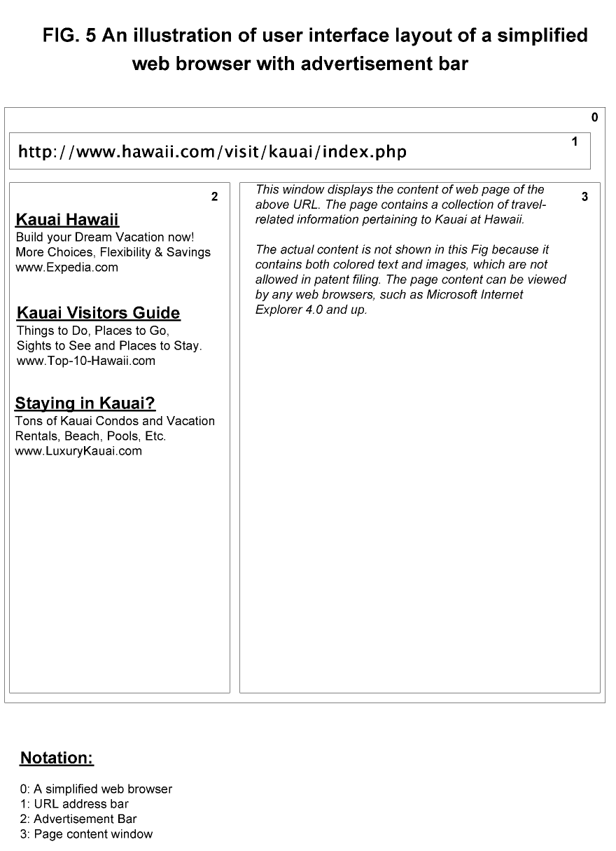

FIG. 5 is a diagram functionally illustrating a user interface layout of a simplified web browser with advertisement bar in one sample implementation. In this implementation, when the browser opens the page, the browser bar will send a request of relevant ads along with this URL to the ad server, the ad server will analyzes the page content of the URL, determines a collection of relevant ads, and send the ads back to the browser bar. The Browser bar will present the ads and provides interactions between the browser bar and the browser page content window.

The web page URL is http://www.hawaii.com/visit/kauai/index.php. The page contains a collection of travel-related information pertaining to Kauai at Hawaii. The web page Title is “Kauai—Kauai Visitor Info—Hawaii Visitor Info—Hawaii”. It could be determined that one or more of each word that appears in the title of the target page corresponds to a topic of the target page. On this basis, the topics for this document may be “Kauai”, “Visitor”, “Info”, and/or “Hawaii”.

Alternatively, it could be determined that one or more of each term that appears in body content of the target web page corresponds to a topic of the page. In the simplest case, each term within the target web page would be identified as a topic. A more complex approach could be performed, such as by using a term vector for the target page, which assigns weights to each term. For example, terms that appear frequently in the target page may be assigned a relatively higher weight than those that appear less frequently. And so the term “the” would have a higher weight than “Kauai”, which would have a higher weight than “visitor”.

In addition, the weighting could be adjusted to give higher weight to terms that appear in some specific element sections, such as hyper links, or a bold text. For example, terms of “Oahu”, “Maui”, “Kauai”, “Big Island”, “Molokai”, and “Lanai” are all appear as hyper links and bold text, and they will be give higher weight.

Alternatively, or in addition to using text or other information within the target page, meta-information associated with the target web page may be used. For example, the “Keywords” and “Description” Meta-tagged fields in the header section of the page contains information describing the target page. The terms in these fields can be added to the topic list or be given higher weight.

In addition, the weighting could be adjusted to give lower weight to terms that appear in a collection of low-quality terms. For example, the term “the” appears so frequently within many web pages that its weight may be reduced or eliminated altogether.

In any situation where terms within text are assigned weights, those resulting scores may be used to determine which terms will be identified as topics for the target web page. For example, it may be determined that the top Z terms (or a subset thereof) will constitute topics for the target web page, with Z being some defined number. Alternatively, or in addition, it may be determined that terms having a score that exceeds Y (or a subset thereof) will constitute topics for the target web page, with Y being some defined number. Or, it may be determined by using some automated clustering techniques, such as K-mean clustering algorithm. The algorithm will partition all the terms into K sets with one set containing highest weighted terms, and these terms can be determined as topics.

Alternatively, or in addition to using the content associated with the target page, the navigation path leading to or starting from the target page may be used. For example, a user maybe first browses to a search web site, such as Http://www.google.com, types in searching keywords of “Hawaii Vacation”, the search site will show a list related as results; the user clicks the site of http://www.hawaii.com/ to open the page. The user then clicks the hyperlink of “Kauai” on the page and to open the target page. The web browser bar will record the navigation history. The topics of navigated pages could be used to revise the topics of the target page. For example, assume the generated topics for search result page are “Hawaii Vacation” and the topics of http://www.hawaii.com/ are “Hawaii Travel Island”. The topics of the navigation history are determined as “Hawaii Vacation Travel Island”. If the topics of the target page contain “Hawaii Vacation Travel”, they are assigned higher weight; otherwise, “Hawaii Vacation Travel Island” may be added to the topics of the target page.

For the sake of clarity, the foregoing references to “revising” the target page are a figurative aid in understanding the use of additional information that is not literally within the target web page. Those skilled in the art will recognize that the target page need not be actually revised to make use of this additional information.

Using one or more of the various techniques described above, or other techniques, one or more topics may be identified for the target web page. Once these topics have been identified, a variety of techniques may be used to determine other topics that are related to those identified topics. For example, a thesaurus could be used to determine other topics that are closely related to the identified topics or that are conceptually similar to the identified topics.

Once the page topics are determined, they are compared against advertisement topics to determine if a match exists. A “match” need not be an exact match. Instead, a match is an indication of a relatively high degree of similarly, and/or a predetermined (e.g., absolute) degree of similarity. If a match exists, the advertisement is determined to be relevant to the target page and may be presented on the web browser bar.

A variety of techniques may be used to provide interaction between the browser bar and the browser page content window. For example, the first ad shown on the web browser bar at FIG. 5 is about a travel agency at Hawaii. Clicking on it cause the ad landing page (http://www.expedia.com/) shown on the browser page content window. There maybe is time-out session for ad displaying. During this session, the ads keep unchanged even if the browser navigates to different URLs. However, after the session expires, when the browser navigates a new URL, the new page will be analyzed and new topics will identified, and the browser bar will be updated with new relevant ads.

C. Conclusion

The foregoing description of preferred embodiments of the present invention provides illustration and description, but is not intended to be exhaustive or to limit the invention to the precise form disclosed. Modifications and variations are possible in light of the above teachings or may be acquired from practice of the invention.

The scope of the invention is defined by the claims and their equivalents.

What is claimed is:

1. The method of serving web page content relevant advertisements using web browser bars, the method comprising: identifying targeting information for an advertisement; identifying a set of one or more topics for the web page based on the content of the targeted page; comparing the targeting information to the set of topics to determine if the advertisement is relevant to the web page; presenting web page content relevant advertisements on web browser bars.

2. The method of claim 1, wherein the advertisement belongs to an advertiser, and wherein identifying targeting information comprises receiving a list of topics from the advertiser.

3. The method of claim 1, wherein identifying a set of one or more topics for the web page comprises analyzing terms within a title of the target web page and including them in the set of one or more topics if the frequency with which they appear in the title exceeds a threshold value.

4. The method of claim 1, wherein identifying a set of one or more topics for the web page comprises calculating a term vector for the target web page based on text within the target web page.

5. The method of claim 4, wherein terms in the term vector are assigned weights based on the frequency with which the terms appear in the text of the target web page.

6. The method of claim 4, wherein terms in the term vector are assigned weights based on the element sections in which terms appear in the text of the target web page, and the element sections comprises: page header, anchor link, and bolded text.

7. The method of claim 4, wherein the set of one or more topics contains terms whose weight exceeds a defined threshold.

8. The method of claim 4, wherein the set of one or more topics includes a defined number of terms with the highest weights among the terms of the term vector.

9. The method of claim 4, wherein the set of one or more topics includes high weighted terms which are separated from low weighted terms using a variety of clustering techniques, wherein the clustering is the partitioning of a data set into subsets so that the data in each subset share some common trait—often proximity according to some defined distance measure.

10. The method of claim 1, wherein identifying a set of one or more topics for the web page comprises: determining zero or more relevant web pages to the target web page; revising the topics of the target web pages with the topics of relevant pages.

11. The method of claim 10, wherein determining zero or more relevant web pages comprises determining that a web page is relevant if the page is in one or more user's web navigation path which leads to or starts from the target web page.

12. The method of claim 11, wherein web navigation path is a list of Y latest visited URLs, wherein Y is a predefined term.

13. The method of claim 11, wherein web navigation path is a list of URLs visited within a given time period Z, wherein Z is a predefined term.

14. The method of claim 10, wherein revising the topics of the target web page comprises: the topics of the target web page are assigned weights based on the topics of relevant web pages.

15. The method of claim 10, wherein revising the topics of the target web page comprises: including topics of relevant web pages into the topics of the target web page.

16. The method of claim 1, wherein determining if the advertisement is relevant to the web page comprises determining advertisements for which keywords have been specified that correspond to a topic that appears in the set.

17. The method of claim 1, wherein presenting web page content relevant advertisements on web browser bars comprises: displaying web page content relevant advertisements on the web browser bars; providing interaction between browser bars and the browser page content window.

18. The method of claim 17, wherein providing interaction between the browser bars and the browser page content window comprises: selecting one or more advertisements in the browser bars may causes the browser page content window show the advertisement related content; changing of the content in the browser page content window may cause the advertisement to be updated in the browser bars.

19. Apparatus for serving relevant advertisements on web browser bars, the apparatus comprising: means for identifying targeting information for an advertisement; means for identifying a set of one or more topics for the web page based on the content of the targeted page; means for comparing the targeting information to the set of topics to determine if the advertisement is relevant to the web page; and means for presenting relevant advertisements on web browser bars.

20. A method for serving relevant advertisements on web browser bars, the method comprising: a step for identifying targeting information for an advertisement; a step for identifying a set of one or more topics for the web page based on the content of the targeted page; a step for comparing the targeting information to the set of topics to determine if the advertisement is relevant to the web page; and a step for presenting relevant advertisements on web browser bas.
